(19) United States
(12) Patent Application Publication
(10) Pub. No.: US 2008/0163101 A1
(43) Pub. Date: Jul. 3, 2008

(54) Managing display windows on small screens

(75) Inventors: Emily Rimas-Ribikauskas, Seattle, WA (US); Dustin von Hubbard, Sammamish, WA (US); Michael H. Fischer, Capitola, CA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/649,040

(22) Filed: Jan. 3, 2007

(51) Int. Cl. G06F 3/048

(52) U.S. Cl. 715/781

(57) ABSTRACT

A technique and apparatus are provided for managing display windows that are too large for viewing on a screen. A screen manager via a re-positioning apparatus, such as a scroll bar, hardware keys, a separate user-interface widget, or the like, re-positions a display window on the screen. The re-positioning apparatus is not part of the display window. The re-positioning apparatus may be manually or automatically initiated. The screen manager is configured to move a portion or the entire display window to a location that is inaccessible to a cursor on the screen.

### BACKGROUND

With the advancement in mobile technologies, many mobile devices today can execute code originally written for execution on a desktop computer. However, the mobile devices typically have screens that are considerably smaller than screens for the desktop computer. Therefore, a display window generated by the code executing on the mobile device may be too large to fit on the small screen. For example, a bottom portion of a dialogue box may not fit on the small screen. If the bottom portion has an “OK”, “Accept”, and “Cancel” button, these buttons would be inaccessible to a user using the mobile device.

The problem often occurs because the display windows are preformatted for the larger screen size and the screen size for the mobile device is smaller than the minimum screen size requirements. An adequate technique for managing large display windows on a small screen has eluded those skilled in the art, until now.

### SUMMARY

Embodiments of the invention are directed at managing display windows that are too large for a screen. Generally stated, embodiments of the invention obtain a location for a top display window on a screen and re-position the top display window on the screen via an apparatus, such as a scroll bar, hardware keys, user-interface element, or the like. Embodiments may further automatically detect when the apparatus is needed to enhance viewing of the top display window on the screen.

### BRIEF DESCRIPTION OF THE DRAWINGS

Many of the attendant advantages of the invention will become more readily appreciated as the same becomes better understood with reference to the following detailed description, when taken in conjunction with the accompanying drawings, briefly described here.

FIG. 1 is an operational flow diagram generally illustrating a process for managing a display window based on a screen size.

FIG. 2 illustrates an apparatus for re-positioning a display window, in accordance with one embodiment of the invention.

FIG. 3 illustrates the display window shown in FIG. 2 after the apparatus has re-positioned the display window on the screen.

FIG. 4 is a functional block diagram of an exemplary computing device that may be used to implement one or more embodiments of the invention.

Embodiments of the invention will now be described in detail with reference to these Figures in which like numerals refer to like elements throughout.

### DETAILED DESCRIPTION OF THE DRAWINGS

Various embodiments are described more fully below with reference to the accompanying drawings, which form a part hereof, and which show specific exemplary implementations for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation, or an implementation combining software and hardware aspects. The following detailed description is, therefore, not to be taken in a limiting sense.

The logical operations of the various embodiments may be implemented (1) as a sequence of computer implemented steps running on a computing device and/or (2) as interconnected machine modules within the computing device. The implementation is a matter of choice dependent on the performance requirements of the computing device implementing the embodiment. Accordingly, the logical operations making up the embodiments described herein are referred to alternatively as operations, steps, or modules.

Generally stated, the described embodiments are directed at managing a display window so that portions of the display window that are currently not viewable on the screen can be seen. The re-positioning of the display window is based on the available screen size. In one embodiment, a scroll bar may be added on the screen to re-position the display window on the screen.

Illustrative Processes

The principles and concepts will now be described with reference to a sample process that may be implemented by a computing device in certain embodiments of the invention. The process may be implemented using computer-executable instructions in software or firmware, but may also be implemented in other ways, such as with programmable logic, electronic circuitry, or the like. In some alternative embodiments, certain of the operations may even be performed with limited human intervention. Moreover, the process is not to be interpreted as exclusive of other embodiments, but rather is provided as illustrative only.

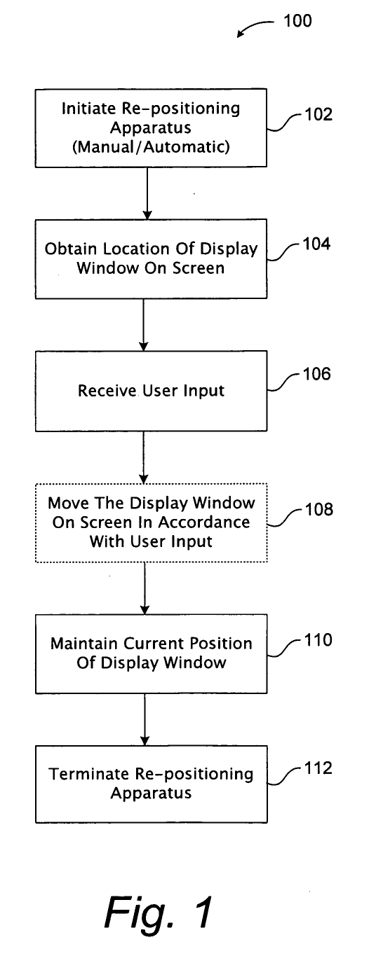

FIG. 1 is an operational flow diagram generally illustrating a process 100 for managing display windows on a screen. At block 102, a re-positioning apparatus is initiated. The re-positioning apparatus may be initiated manually and/or automatically. For example, a user may initiate the re-positioning apparatus manually by clicking on a toolbar in a task bar. For automatic initiation, process 100 may monitor a location and size for a top display window being displayed on a screen. If a pre-determined portion of the top display window is not viewable on the screen, the re-positioning apparatus may automatically be initiated. There are several embodiments envisioned for the re-positioning apparatus, such as a scroll bar, a widget-like user-interface element, hardware keys, or the like. For example, in one embodiment, a child window may be created that contains the scroll bar. For embodiments in which the re-positioning apparatus is visible on the screen, one will note that the re-positioning apparatus may look as if the re-positioning apparatus is part of the display window, but the re-positioning apparatus is not a part of the display window and the display window need not have any prior knowledge about the interaction with the re-positioning apparatus. Processing continues at block 104.

At block 104, a location for the top display window on the screen is obtained. If process 100 is initiated automatically, the location may have already been calculated. Otherwise, process 100 obtains coordinates for the top display window and identifies the top display window. Processing continues at block 106.

At block 106, user input is received via the re-positioning apparatus. In the embodiment in which the re-positioning apparatus is a scroll-bar, the scroll-bar may have a height equal to the screen less the size of the task bar. A user may then interact with the scroll-bar in a well-known fashion. In other embodiments, the process may recognize user input based on the selection of a specific hardware key or a user-interface widget. Processing continues at block 108.

At block 108, the top display window is re-positioned on the screen in accordance with the user input that is received via the re-positioning apparatus. For example, when the user moves the scroll bar, the top display window is moved up, down, left or right accordingly. When the window is moving, the coordinates of the top display window may be set to a restricted location where the cursor can not access the top display window. For example, the top display window may be placed at coordinate (40,−20). This allows the re-positioning apparatus to move a portion of the display window or the entire display window“off the screen” where the cursor cannot access the display window, but where the re-positioning apparatus can access the display window. Thus, allowing the process to move the display window around on the screen based on the user inputs. One will note, however, that the display window itself does not need to have any prior knowledge of the interaction of the re-positioning apparatus with the display window. In addition, even though the re-positioning apparatus is moving the display window on the display, window events and formatting of the window are not disturbed. Processing continues at block 110.

At block 110, a current position for the top display window is maintained as the top display window is re-positioned on the screen. This allows the re-positioning apparatus to move in unison with the re-positioning of the top display window. Processing continues at block 112.

At block 112, the re-positioning apparatus is terminated. This may occur automatically when the top display window that is being re-positioned is closed. In another embodiment, a user may manually terminate the re-positioning apparatus. When a user manually terminates the re-positioning apparatus, the top display window may be re-positioned to a pre-determined optimal viewing position on the screen, such as positioning the top window so that the top of the title bar is moved to the top of the screen and the center of the top display window is centered on the screen. By re-positioning the display window to a pre-determined optimal viewing position based on the display window and the screen, the display window does not inadvertently become stranded off screen. The re-positioning apparatus may then be manually or automatically initiated again for this or a different display window on the screen in accordance with process 100. In addition, multiple display windows may have the re-positioning apparatus control the position of the display window based on which display window is active when the re-positioning apparatus receives user input.

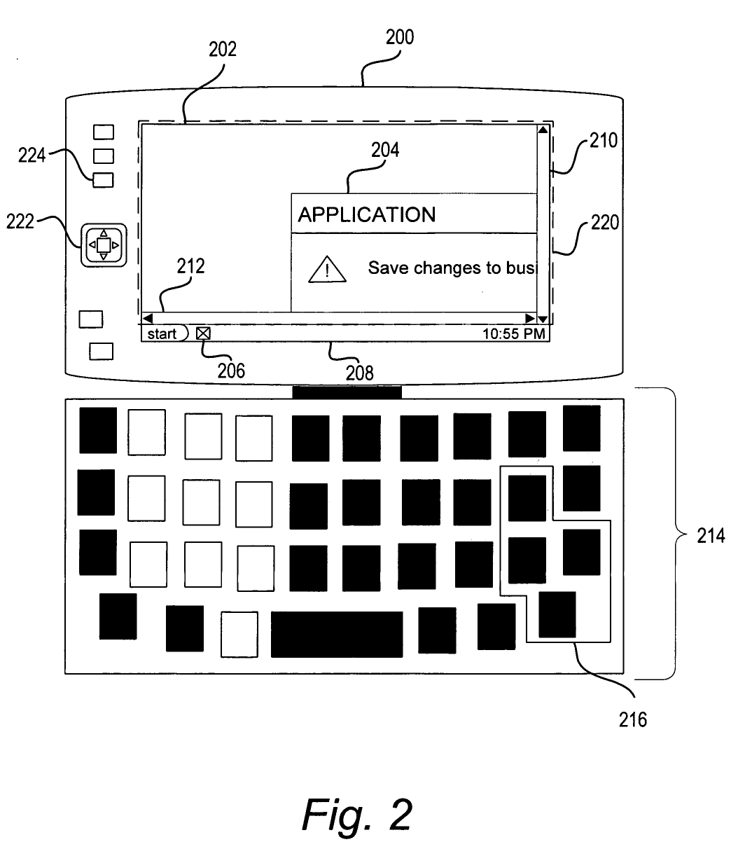

FIG. 2 illustrates an apparatus for re-positioning a display window, in accordance with one embodiment of the invention. A computing device 200 is shown with a screen 202. A top display window 204 is displayed on the screen 202. One will note that the bottom portion of the top display window 204 is not visible on screen 202 because the screen is too small. As discussed above, a re-positioning apparatus may be initiated automatically by recognizing that the screen 202 does not adequately display the top display window 204. Alternatively, the re-positioning apparatus may be initiated manually by a user, such as by selecting a toolbar 206 in a taskbar 208, by selecting some other user-interface element, by pressing a hardware button, such as button 224, or the like. The re-positioning apparatus may include a child window (represented as dashed box 220) having a vertical scroll bar 210 and a horizontal scroll bar 212. One will note that if the top display window fits horizontally within screen 202, horizontal scroll bar 212 may not be included in the re-positioning apparatus and vice versa. Instead of the horizontal scroll bar 212 and vertical scroll bar 210, the re-positioning apparatus may include a hardware button, such as button 222, or a set of keys 216 out of optional keys2l4available on the computing device. The present technique then associates an up, down, left, and right movement with a respective key/button.

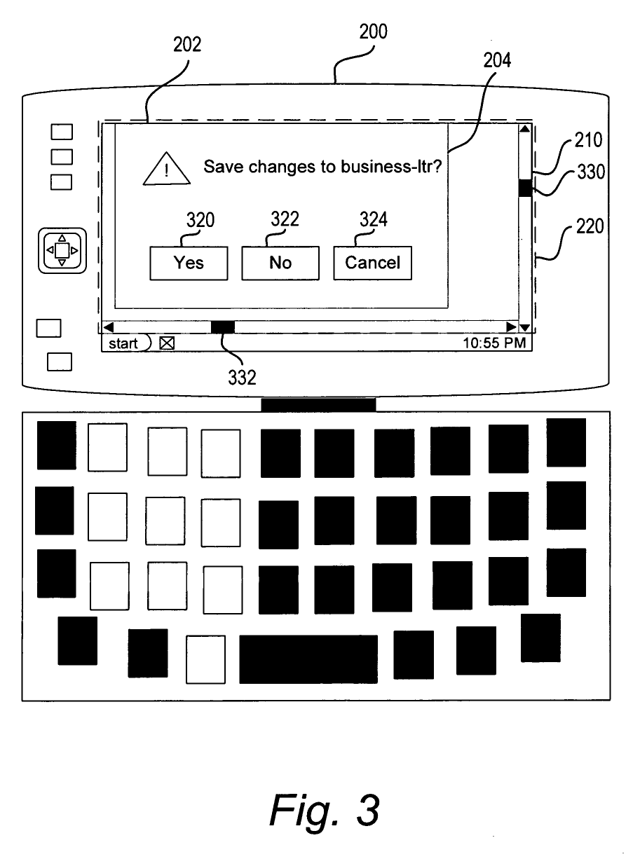

FIG. 3 illustrates the display window shown in FIG. 2 after the apparatus has re-positioned the display window on the screen. One will note that the top display window is now positioned such that the top portion of display window 204 is not visible, but the bottom portion is visible within screen 202. Thumbs 330 and 332 indicate the relative re-positioning of display window 204 on screen 202. By re-positioning top display window 204 in this manner, yes button 320, no button 322, and cancel button 324 have become visible. Without the present re-positioning apparatus, a user would be unable to position the display window 204 so that buttons 320-324 could be viewed. For example, dragging the display window 204 to the top of screen 202 would still not allow buttons 320-324 to be visible. As mentioned above, scroll bars 210 and 212 may appear to be a part of the top display window, but in actuality the top display window does not need any prior knowledge that the scroll bars exists. This allows programs written for desktops to be ported to mobile devices without modifications. While not shown, other display windows displayed on screen 202 may also be re-positioned using the same re-positioning apparatus. When multiple display windows are associated with the same re-positioning apparatus, the re-positioning apparatus moves the display window that is currently active.

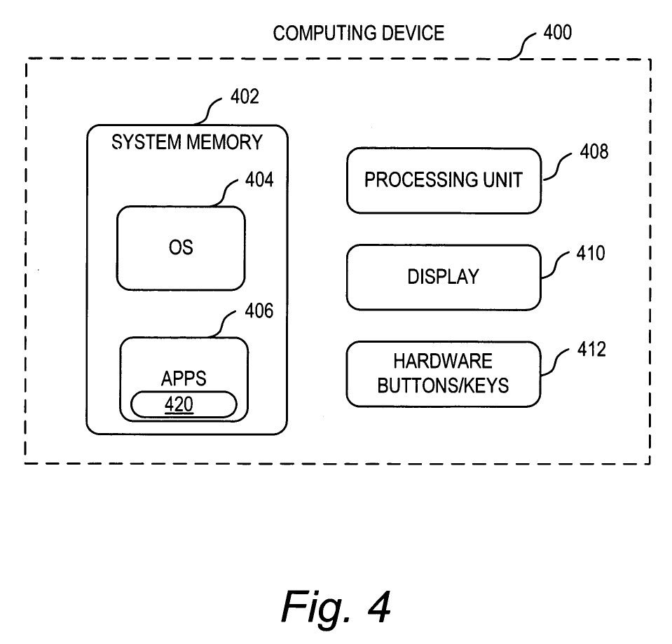

FIG. 4 is a functional block diagram of an exemplary computing device that may be used to implement one or more embodiments of the invention. The computing device 400, in one basic configuration, includes at least a memory 402 and processing unit 408. Depending on the exact configuration and type of computing device, memory 402 may be volatile (such as RAM), non-volatile (such as ROM, flash memory, etc.) or some combination of the two. System memory 402 stores an operating system 404 and one or more applications 406. Computing device 400 also includes a display, which may be touch-sensitive, 410 and an optional hardware button(s)/key(s) 412. For the present invention, applications 406 includes a screen manager 420 that is configured to manage the screen via a re-positioning apparatus as described above.

Memory 402 is an example of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 400. Any such computer storage media may be part of device 400. The basic operation of computing device 400 is well known in the art and need not be discussed at length here.

The advantages of the invention are many. For example, by having the screen manager provide a re-positioning apparatus, applications written for desktop computers can be executed on computing devices with smaller screens without modifying the applications. This allows programs written for desktops to be ported to mobile devices.

Although the subject matter has been described in language specific to structural features and/or methodological acts, it is to be understood that the subject matter defined in the appended claims is not necessarily limited to the specific features or acts described above. For example, the subject matter has been described for viewing large pre-formatted windows on small screens. However, the subject matter will also operate on large screens. Rather, the specific features and acts described above are disclosed as example forms of implementing the claims.

1. A computer-readable medium having computer-executable instructions for managing display windows on a screen, comprising:
obtaining a location of a display window on the screen, the entire display window being too large to be viewed at one time on the screen;
receiving user input via a re-positioning apparatus that is not a part of the display window; and
moving the location of the display window on the screen based on the user input.

2. The computer-readable medium recited in claim 1, further comprising manually initiating the re-positioning apparatus.

3. The computer-readable medium recited in claim 2, wherein manually initiating the re-positioning apparatus comprises selecting a toolbar associated with the re-positioning apparatus in a taskbar displayed on the screen.

4. The computer-readable medium recited in claim 1, further comprising automatically initiating the re-positioning apparatus.

5. The computer-readable medium recited in claim 4, wherein automatically initiating the re-positioning apparatus comprises monitoring the location of the display window in relation to the size of the screen and initiating the re-positioning apparatus when a pre-determined portion of the display window is not viewable on the screen.

6. The computer-readable medium recited in claim 1, wherein the re-positioning apparatus comprises a scroll bar displayed in a child window on the screen.

7. The computer-readable medium recited in claim 6, wherein movement of the scroll bar and the display window are in unison.

8. The computer-readable medium recited in claim 1, wherein the re-positioning apparatus comprises a set of keys on a keypad of a computing device.

9. The computer-readable medium recited in claim 1, wherein moving the display window comprises moving a portion of the display window where a cursor can not access the display window.

10. The computer-readable medium recited in claim 1, further comprising terminating the re-positioning apparatus when the display window closes.

11. The computer-readable medium recited in claim 1, further comprising manually terminating the re-positioning apparatus.

12. The computer-readable medium recited in claim 1, wherein the re-positioning apparatus moves another display window on the screen instead of the display window.

13. A computer-executable method comprising:
creating a child window with a scroll bar;
displaying the child window on a screen;
receiving user input via the scroll bar; and
re-positioning a display window on the screen based on the user input, the child window not being a part of the display window.

14. The computer-executable method recited in claim 13, wherein the child window is manually initiated by selecting a toolbar displayed in a taskbar on the screen.

15. The computer-executable method recited in claim 13, wherein the child window is automatically initiated when a pre-determined portion of the display window is not viewable on the screen.

16. The computer-executable method recited in claim 13, wherein re-positioning the display window comprises moving a portion of the display window to a location that is inaccessible to a cursor.

17. A computing device configured to manage display windows on a screen, the computing device comprising:
a processing unit;
a screen; and
a memory into which a plurality of instructions are loaded, the plurality of instructions comprising:
a screen manager configured to re-position a display window on the screen in a manner that allows previously hidden portions of the display window to be viewable on the screen;
a re-positioning apparatus this is configured to receive user input and to communicate the user input to the screen manager to guide the re-positioning of the display window, the re-positioning apparatus not being a part of the display window.

18. The computing device recited in claim 17, wherein the re-positioning apparatus comprises a scroll bar displayed in a child window on the screen.

19. The computing device recited in claim 18, wherein movement of the scroll bar and the display window are in unison.

20. The computing device recited in claim 17, wherein the re-positioning apparatus comprises a set of keys on a keypad of the computing device and a left, right, up, and down direction is associated with a respective key in the set.
